(19) United States
(12) Patent Application Publication
(10) Pub. No.: US 2014/0298902 A1
(43) Pub. Date: Oct. 9, 2014

(54) System and Method for Environmental Measurements

(71) Applicants: Wes Clayton Fannin, Weyauwega, WI (US); Pauly Joseph Paul, New Holstein, WI (US); Ronald James Ingraham, Milwaukee, WI (US); Eric Lee Ireland, Milwaukee, WI (US)

(72) Inventors: Wes Clayton Fannin, Weyauwega, WI (US); Pauly Joseph Paul, New Holstein, WI (US); Ronald James Ingraham, Milwaukee, WI (US); Eric Lee Ireland, Milwaukee, WI (US)

(21) Appl. No.: 13/858,774

(22) Filed: Apr. 8, 2013

(51) Int. Cl. G01F 23/28; G01F 23/292; G01F 23/296

(52) U.S. Cl. CPC G01F 23/282; G01F 23/2961; G01F 23/2921
USPC 73/290 V; 73/290 R

(57) ABSTRACT

A system for conducting measurements in an environment of a fluid containment and for displaying said measurements in real time is disclosed. The system contains a plurality of sensors including a distance sensor, a gyroscope and optionally a rainfall gauge and a methane sensor. The signals are processed by a communication converter and a central processing unit, then transmitted through an antenna to a receiver containing a modem.

### RELATED APPLICATIONS

This application claims priority from provisional application No. 61/621,991 filed on Apr. 9, 2012.

### FIELD OF THE INVENTION

The present invention relates to a system and a method for providing real time measurements of environmentally sensitive systems. More specifically, the present invention relates to a system and a method for taking multiple measurements of manure lagoons, pits and manure tanks which may be either open or enclosed tanks and displaying the results in real time. These measurements may include but not limited to: liquid level, wind direction, vibration level, methane content and rainfall amount.

### BACKGROUND OF THE INVENTION

Animal manure is produced in farms on a regular basis. The manure presents a contamination hazard to the underground water table and therefore must be disposed in an environmentally responsible manner.

The manure is typically collected in containments such as lagoons or tanks. To avoid the risk of overflowing, state DNRs require farms to monitor the level of manure in the containments and take action if a critical level has been reached which then presents a danger of overflow. Other measurements in the containment environment that may provide useful information are: methane gas content, wind speed and direction, the amount of rainfall and the content of carbon dioxide and that of other green house gases.

### SUMMARY OF THE PRESENT INVENTION

In one aspect of the present invention, a system for conducting measurements in an environment of a fluid containment and for displaying the measurements in real time, the containment containing a fluid having a varying height in the containment, the system comprises: a platform; a distance sensor disposed on the platform, the distance sensor being adapted for generating a signal proportional to a distance from a sensing member of the distance sensor to a surface of the fluid in the containment; a signal transmitter comprising a communication converter, a central processing unit and an antenna, the signal transmission system being in communication with the distance sensor, the signal transmitter being configured for processing and transmitting the distance proportional signal to a remote signal receiver, the remote signal receiver being adapted for receiving signals and converting the signals into corresponding measurements; a power supply system comprising a power source, a charge controller and a power regulator, the power supply system being adapted to power the distance sensor and the signal transmitter, the power supply system being disposed on the platform; and software adapted for displaying the sensor readings and performing calculations.

These and other features, aspects and advantages of the present invention will become better understood with reference to the following drawings, description and claims.

### BRIEF DESCRIPTION OF THE DRAWINGS

FIG. 1 is a side cross sectional view of the measuring system installed over a manure tank according to an embodiment of the present invention;

FIG. 2 is a side cross sectional view of the measuring system installed over a manure lagoon according to an embodiment of the present invention; and

FIG. 3 is a schematic of the overall system for conducting environmental measurements according to an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

The present invention relates to a system and method for conducting environmental measurements around containments containing fluids. The manure collected in farms is stored in containments such as lagoons, in-ground pits and open or closed tanks. These containments are regulated by DNR departments to insure that a manure spill does not result in contaminating the underground water.

Monitoring the levels of fluid that contain manure contaminants in these containments is of primary importance. Other measurements may include but not limited to green house gas contents such as methane and carbon dioxide, the level of vibration, and amount of rainfall. It would be desirable to provide such measurements in real time and at regular frequencies. It would also be desirable to construct a system that operates at a battery voltage level of 12V as these systems would be placed in outdoor environments that typically lack access to a 110V power source. Likewise, it would be desirable to have a system that operates at the relatively low power levels in the range of 1-20 watts. Another challenge that is solved by the present invention is providing a signal processing and transmission system capable of handling a large number of measurements.

The system of sensors, power supply, and transmission of signals is placed on a platform above the containment such that the sensors have access to the areas where the measurements are made.

In one embodiment of the present invention, the fluid level measurements are performed by an ultrasonic sensor from a fixed position at a predetermined distance above the liquid plane of the tank. The Ultrasonic sensor sends a signal from a point above the containments which bounces back when it hits a surface which may be that of a solid or a liquid. Sensors that are at present commercially available such as Parallax's PING)))™ and Senix® Ultrasonic Sensor LVL are examples of sensors that are suitable for this application. Optionally, a laser range finder and sensor maybe used to perform these measurements. The ultrasonic sensor is configured to transmit a signal perpendicular to both the sensor and the liquid line at a predetermined speed. In this configuration, the signal bounces off the water and travels back to the sensor which then calculates the distance from the sensor to the fluid surface from the travel time and signal speed. While the distance of the sensor from the liquid level will vary, the preferred range is between about 40 ft to about 150 ft.

Because the distance is measured as the straight line between the transmission point and the fluid surface, it is imperative that the level of platform vibration not exceed a certain threshold. Excessive vibration may distort the angle of transmission and provide inaccurate readings. Thus, distance readings made when vibration levels are high, need to be disqualified. A variety of commercial gyroscopes might be used for vibration measurements. An iMEMS0 gyroscope made by Analog Devices, Inc. is an example of a device suitable for this application. Sensor devices for measuring methane content in the atmosphere and rainfall amounts are likewise commercially available.

The present invention provides for periodic measurements that are convertible to signals transmittable through a number of different media into a personal computer or computer network that are translated into length measurements readable on the computer. Measurements frequency is adjustable; however it is likely that at least two measurements would be taken daily. The measurements are transmitted at the time of measurement, however, if an outgoing connection fails, the system is configured for storing the data onboard and sent when the system connectivity is restored.

The present invention provides for a system that uses remote telemetry designed to capture the signals for the sensor, process the signals and convert them into transmittable data, then transmit the processed data to an internet based server for dissemination to end users via secured login.

The basic architecture of the measurement system may comprise of:

1. A signal transmitter,

2. A signal receiver,

3. A communication converter,

4. A Central Processing unit (CPU), and

5. A modem for transferring received information to the internet.

The software used for transmitting and processing the signals from the ultrasonic device to the internet comprises of software installed on the device and online software. The software on the device comprises of programs and code on the CPU and its associated electronics. The CPU is connected to the range finder by a communication converter. The connection can be in analog or in digital form. The online software is the software that is hosted on a server that receives the data from the software installed on the device through the internet. The function of the software installed on the device is to provide communication between the system modules and to transmit data collected by the modules to the internet via cellular modem, satellite modem, or standard wifi. The function of the online software is to receive, save, display and manipulate the data from the device. For example, this software covers raw readings for the “length” between the sensor and tank liquid surface to calculated tank levels. A suitable modem for transferring the processed signals to the internet is a type 3 G or a 4 G high speed modem.

One function of the Central Processing unit is to turn on a transistor that promps the power supply unit to turn on the ultrasonic sensor which automatically starts the measurement algorithm. Mounting the sensor above the open pit must be done such that it will preclude the likelihood of the sensor being bumped and shifted. If the sensor shifts or not installed in a position directly above the liquid, the measurement will be off by many degrees or will result in no measurement. This will result in an event being created in the software under pit level alerts.

The communication converter function is performed by a transistor-transistor logic (TTL) module having a gating and amplifying function that enable processing disparate signals such as from a range finder and a gyroscope.

The ultrasonic sensor is hardwired to a TTL converter that is hardwired to a serial port on the CPU. The CPU does some basic analysis on the data looking for out of bounds data, and then converts the data into the format required to be sent via wifi/ethernet/cell modem to the internet server.

In the configuration of the present invention, all sensors communicate with the Central Processing Unit. The data from the ultrasonic sensor is in a digital form and is converted from a device specific range to inches. Then additional meta data is added to it to identify the individual pit and time data. All data from all sensors are pre-filtered and packaged by the CPU. The rain sensor produces a tick every 1/1000^{th} of an inch. The CPU keeps count of these pulses, packages them to a total rain fail amount, waits a certain amount of time after the last pulse to determine the end of the rainfall event, and then package the time data and the sensor output to the web server for display to the end user. The system currently has parts/devices that run at 3.3v, 5v, 12v, and 24v.

The Central Processing Unit of the present invention is configured for processing “length” signals in the range of the ultrasonic sensor measurements. To accomplish this, the CPU contains a source code and software compatible with the range readings and configured for transmitting the coded signal through the internet.

Other sensors that provide useful data also fall within the scope of the present invention. These may include a methane sensor, a wind speed and direction sensor, a backup laser level sensor, a rain fall sensor and a camera that provides a visual perspective. The system is design to operate at power levels of between about 1 watt to about 20 watts. Powering the system may be accomplished by a solar panel or battery.

Additional components such as an input-output (I/O) board and a dc voltage to dc voltage converter may be needed to accommodate some of the sensors. For example, sensors that operate at a PC voltage of 5V need need to interface with a voltage converter to operate at the embedded 12V.

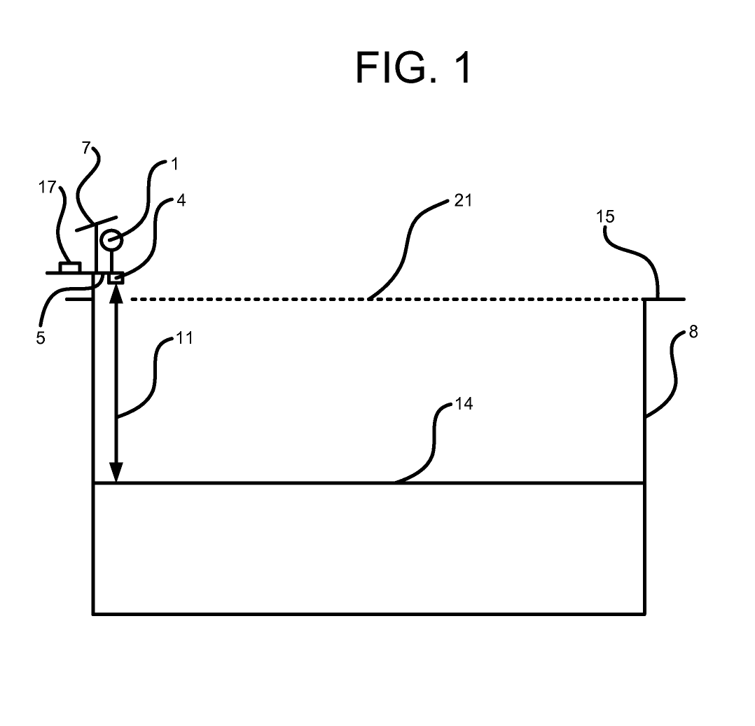

The present invention is illustrated in FIGS. 1-3. FIG. 1 shows the components of the measurement system situated on a platform 5 above a tank 8. These include the sensor pack 4 that may include the ultrasonic or laser sensor, the gyroscope, methane and other gas sensors and rainfall gauge, antenna 7, solar panel 1 and module 17 that contains the battery pack and the electronic components associated with the communication converter and voltage converter. The containment liquid level 14 varies due to waste going into it, removal of manure liquid and rainfall into the containment. The containment may have a top enclosure 21.

The distance sensor transmits a signal straight down into the manure pit 8 that bounces off the liquid level and back to the sensor 4 resulting in the measurement of the distance 11 between the liquid level 14 and the sensor. After the signal is converted by the CPU to a digital form, the signal is picked up by transmission antenna 7. The platform may be mounted on a swivel arm configured to rotate and reposition the sensors.

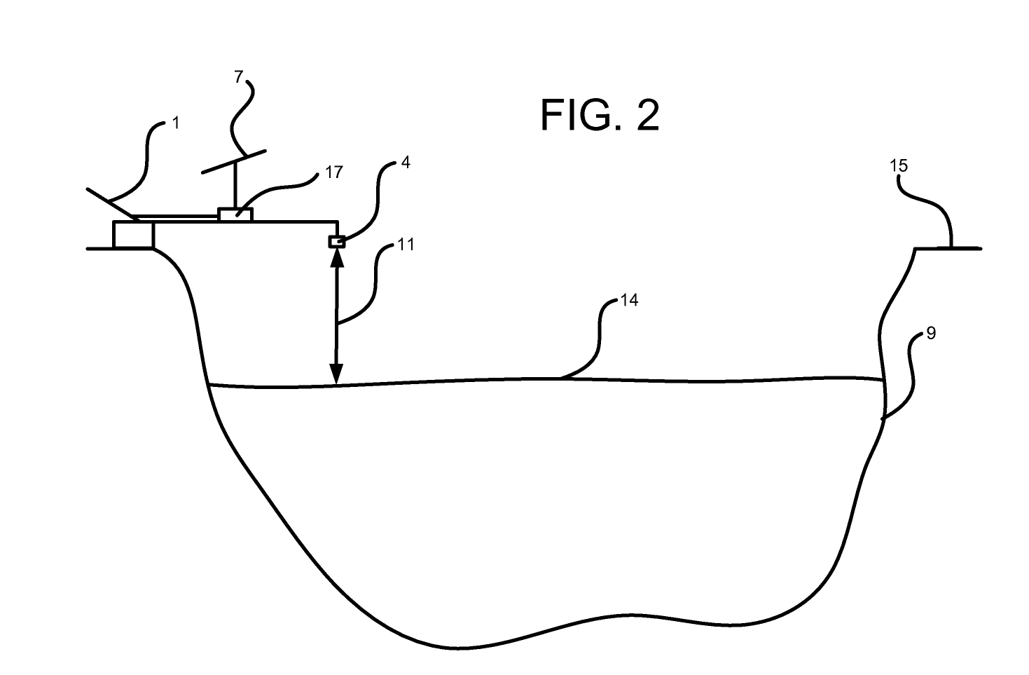

FIG. 2 shows the components of the measurement system situated on a platform 5 above a manure lagoon 9. Shown are the sensor pack 4, antenna 7, solar panel 1 and module 17 that contains the battery pack and the electronic components associated with the communication converter and voltage converter.

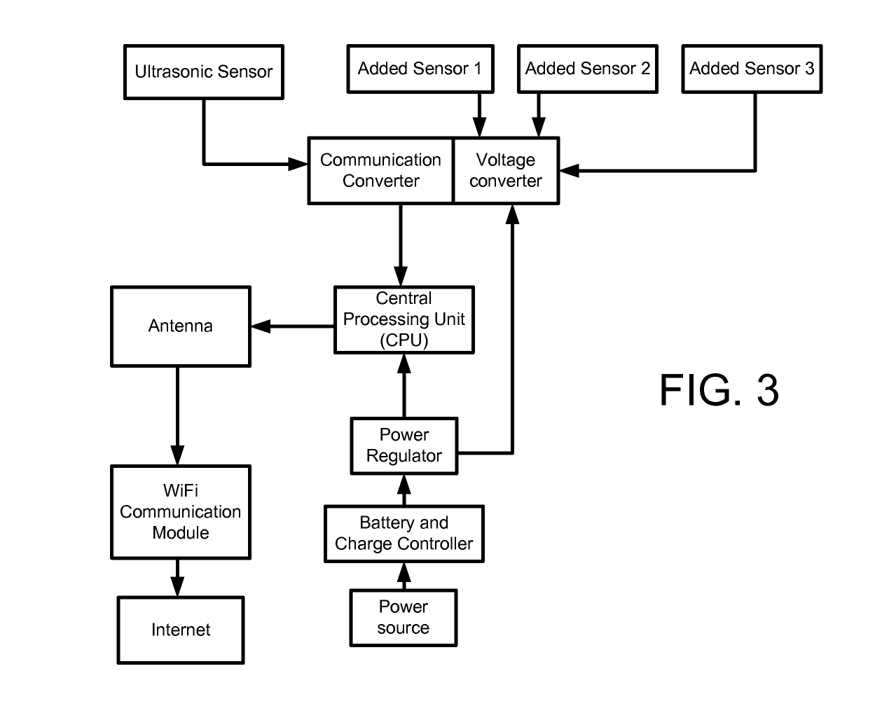

FIG. 3 is a diagram of the components of the system. Shown are the Central Processing Unit (CPU) that receives signals from the sensors through the communication converter and voltage converters as appropriate. The processed signals are transmitted through the antenna to a remote receiver that includes a modem and being displayed on the internet in real time.

While the present invention is directed to containments containing manure, the system of measurements described here may be also used in processes involving fluid levels in tanks where gases are generated including sewage, tanks containing various chemicals and fisheries.

It should be understood, of course, that the foregoing relates to exemplary embodiments of the invention and that modifications may be made without departing from the spirit and scope of the invention.

We claim:

1. A system for conducting measurements in an environment of a fluid containment and for displaying said measurements in real time, said containment containing a fluid having a varying height in the containment, said system comprising:
a platform;
a distance sensor disposed on said platform, said distance sensor being adapted for generating a signal proportional to a distance from a sensing member of the distance sensor to a surface of the fluid in the containment;
a signal transmitter comprising a communication converter, a central processing unit and an antenna, said signal transmission system being in communication with said distance sensor, said signal transmitter being configured for processing and transmitting the distance proportional signal to a remote signal receiver, said remote signal receiver being adapted for receiving signals and converting the signals into corresponding measurements;
a power supply system comprising a power source, a charge controller and a power regulator, said power supply system being adapted to power the distance sensor and the signal transmitter, said power supply system being disposed on the platform; and
software adapted for displaying the sensor readings and performing calculations.

2. The system for conducting measurements in an environment of a fluid containment and for displaying said measurements in real time of claim 1, wherein the distance sensor is an ultrasonic sensor.

3. The system for conducting measurements in an environment of a fluid containment and for displaying said measurements in real time of claim 1, wherein the distance sensor is a laser range finder and sensor.

4. The system for conducting measurements in an environment of a fluid containment and for displaying said measurements in real time of claim 1, further comprising a gyroscope sensor for sensing excessive vibrations in the distance sensor, said gyroscope sensor being disposed on the platform, said gyroscope sensor generating a vibration signal proportional with a level of vibration, said signal being transmitted through the signal transmitter and processed by the remote receiver.

5. The system for conducting measurements in an environment of a fluid containment and for displaying said measurements in real time of claim 4, further comprising at least one sensor for conducting environmental measurements of the containment.

6. The system for conducting measurements in an environment of a fluid containment and for displaying said measurements in real time of claim 5, wherein one sensor is a rainfall sensor said rainfall sensor being disposed on the platform, said rainfall sensor generating a rainfall signal proportional with an amount of rainfall, said is rainfall signal being transmitted through the signal transmitter and processed by the remote receiver.

7. The system for conducting measurements in an environment of a fluid containment and for displaying said measurements in real time of claim 5, wherein one sensor is a methane gas sensor said methane gas sensor being disposed on the platform, said methane gas sensor generating a methane gas signal proportional with an amount of methane gas present in the containment, said methane gas signal being transmitted through the signal transmitter and processed by the remote receiver.

8. The system for conducting measurements in an environment of a fluid containment and for displaying said measurements in real time of claim 1, wherein the remote receiver comprises a modem configured for direct communication with the internet.

9. The system for conducting measurements in an environment of a fluid containment and for displaying said measurements in real time of claim 1, further comprising a voltage converter.

10. The system for conducting measurements in an environment of a fluid containment and for displaying said measurements in real time of claim 1, wherein the communication converter contains a transistor-transistor logic converter.

11. The system for conducting measurements in an environment of a fluid containment and for displaying said measurements in real time of claim 1, wherein the power supply system comprises at least one solar panel and at least one rechargeable battery configured to supply about 12 volts.

12. The system for conducting measurements in an environment of a fluid containment and for displaying said measurements in real time of claim 4, further comprising a software program for flagging fluid level measurements obtained at times when the vibration signal exceeded a preset threshold.
